(19) United States
(12) Patent Application Publication
(10) Pub. No.: US 2004/0199587 A1
(43) Pub. Date: Oct. 7, 2004

(54) Company-only electronic mail

(76) Inventor: Russell F. McKnight, Sioux City, IA (US)

Correspondence Address: Gateway, Inc., Scott Charles Richardson, 605 Gateway Drive, MD Y-04, N. Sioux City, SD, 57049, US

(21) Appl. No.: 10/404,843

(22) Filed: Apr. 1, 2003

(51) Int. Cl. G06F 15/16

(52) U.S. Cl. 709/206

(57) ABSTRACT

Systems and methods for providing company-only e-mail are disclosed. The systems and methods detect a tag in an e-mail that designates the e-mail as “company only.” If the tag is present, the systems and methods of the present invention prevent the e-mail from being sent to a recipient that is not within the company. In one aspect, the system detects the tag within an e-mail client. In another aspect, the system detects the tag within an e-mail server. In still another aspect, the system detects the tag within a firewall. In a still further aspect, the system detects the tag within a suitably configured router. Upon detection of a company-only tag, the e-mail is prevented from being sent to an entity that may route the e-mail to a non-company destination.

### FIELD

The present invention relates to electronic mail systems, and in particular to electronic mail systems that limit distribution of certain electronic mail to recipients within a company.

### BACKGROUND

One of the early uses of networks in general and of the Internet was the sending and receiving of electronic mail (e-mail). E-mail continues to be an important use of the Internet, with more and more making use of the Internet every day. Additionally, companies are making more use of e-mail to communicate both internally and externally as it is typically faster than sending an item through physical mail channels such as a postal service.

E-mail, like its physical counterpart, must have a properly formatted destination address in order to reach the intended recipient. E-mail addresses generally take the form of “user@domain,” where the “user” portion of the address represents a user identifier associated with a particular user or entity, and the “domain” portion provides a network address that manages e-mail for a domain. A domain can be a company, an organization, a governmental entity, or any other grouping of users on a network segment. For example, the e-mail address “john_doe@gateway.com” represents the user john_doe whose network address is gateway.com, the network address for Gateway, Inc. An e-mail item may have more than one recipient address listed, and in fact, there may be many recipients specified.

While e-mail provides a convenient and easy way to quickly send information to people, the features that make it easy to use can also lead to problems. For example, with the click of a mouse button, a user may send important company trade secrets to a competitor, with potentially disastrous results. Even if the user intends to send sensitive information to a particular recipient, there is no guarantee that the intended recipient will not forward the e-mail other parties that the sender did not wish to receive the information.

Previous systems have attempted to deal with the above-described problem by providing “sensitivity” indicators. For example, the Microsoft Outlook® e-mail client from Microsoft® Corporation provides a means for a user to designate an e-mail as “confidential.” However, such a designation is generally advisory only; that is, there is no mechanism to enforce the confidentiality of the e-mail. The recipient is free to do whatever the recipient wants with the e-mail after it has been received.

In view of the problems and issues noted above, there is a need in the art for the present invention.

### SUMMARY

The above-mentioned shortcomings, disadvantages and problems are addressed by the present invention, which will be understood by reading and studying the following specification.

Embodiments of the invention detect a tag in an e-mail that designates the e-mail as “company only.” If the tag is present, the systems and methods of the present invention prevent the e-mail from being sent to a recipient that is not within the company.

In one aspect, the system detects the tag within an e-mail client. In another aspect, the system detects the tag within an e-mail server. In still another aspect, the system detects the tag within a firewall. In a still further aspect, the system detects the tag within a suitably configure router. Once detected, an e-mail having the tag is prevented from being sent outside of the company.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram of the logical components of a system for sending company-only e-mail that incorporates embodiments of the invention.

FIGS. 2A-B are flowcharts illustrating methods for sending company-only e-mail according to embodiments of the invention.

FIG. 3 is an architectural block diagram of a computer system utilizing the current invention.

### DETAILED DESCRIPTION

In the following description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

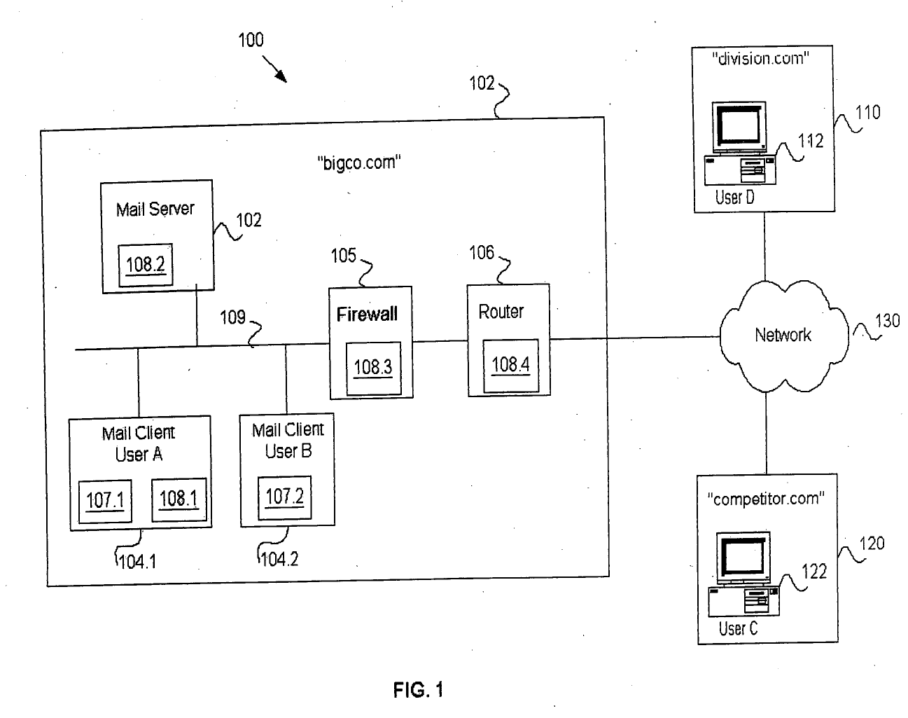

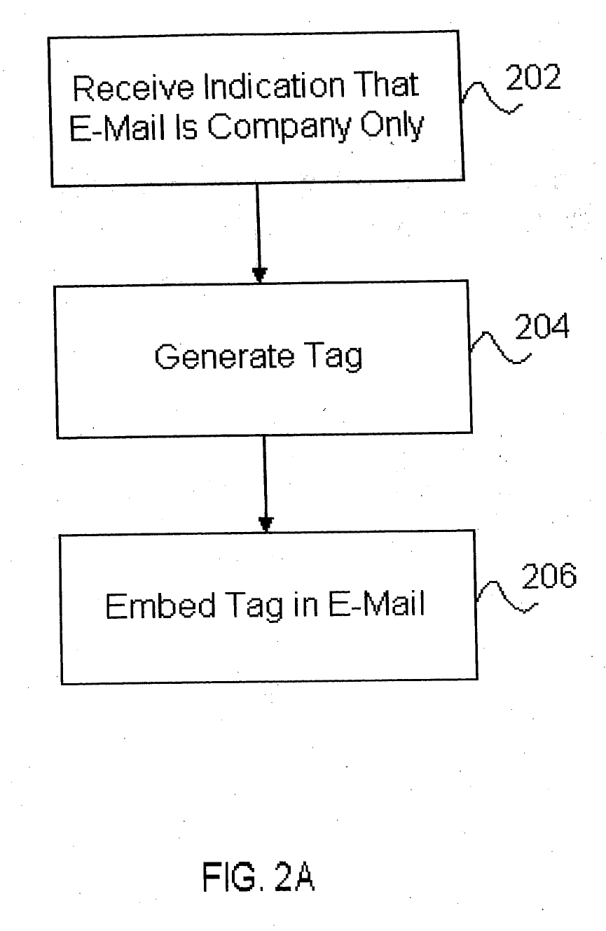

FIG. 1 is a block diagram of an exemplary system 100 incorporating embodiments of the invention for sending and receiving company-only electronic mail (e-mail). Exemplary system 100 illustrates a system for e-mail communication between and within three exemplary domains (101, 110 and 120) communicably coupled over network 130. In some embodiments, network 130 is the Internet, however the invention is not limited to any particular network architecture or type.

In the exemplary system, domain 101 represents the address domain for “bigco.com,” which, for illustrative purposes is a large company. Domain 110 represents the address domain for “division.com,” which for illustrative purposes is a division of the company having domain 101. Domain 120 represents the address domain for “competitor.com,” which for illustrative purposes represents a company that competes with the company having domain 101. Those of skill in the art will appreciate that many other address domains exist, and that the domains illustrated may be divided into sub-domains (not shown). For example, bigco.com might be divided into “management.bigco.com” representing an address domain for management employees of bigco.com, and “research.bigco.com” representing and address domain for employees engaged in research at bigco.com.

Within each address domain there may be a number of entities that process e-mail. For example, within exemplary address domain 101 there is at least one mail server 102, mail clients 104, firewall 105 and router 106, all communicably coupled within internal network 109. Mail server 102 comprises one or more computer programs that provide e-mail services to mail clients 104. Examples of such services include the reception and storage of e-mail, and the assignment and management of e-mail user identifications (IDs), Various mail servers are available; an example of a mail server is the Microsoft Exchange® e-mail server from Microsoft® Corporation. The invention is not limited to any particular type of mail server.

Mail client 104 comprises a computer program or set of programs that an individual end-user uses to compose, send, receive, and manage e-mail items. Mail client 104 typically communicates with mail server 102. Examples of mail clients include the Microsoft Outlook® client from Microsoft® Corporation, and the Lotus Notes® mail client from Lotus Development Corporation. Numerous other mail clients exist, those of skill in the art will appreciate that the invention is not limited to any particular type of mail client.

Firewall 105 may be used in the exemplary environment to prevent unauthorized Internet users from accessing private networks connected to the Internet, especially intranets. All messages entering or leaving the intranet typically pass through the firewall, which examines each message and blocks those that do not meet the specified security criteria. As is known in the art, firewall 105 may be implemented in both hardware and software, or a combination of both.

Router 106 comprise software and hardware that routes network data between internal network 109 and network 130. The network data can include e-mail data to and from systems that are external to domain 101. Other types of network hardware can be substituted for or used in addition to router 106. Examples of such network hardware include gateways, switches, hubs, and/or bridges.

Those of skill in the art will appreciate that domains 110 and 120 may include components similar to that of domain 101. However, in order to more clearly describe the system, internal details regarding domains 110 and 120 are not repeated.

In some embodiments of the invention mail client 104 contains a tag generation module 107. Tag generation module 107 operates to place a tag in e-mail that has been designated as “company-only,” that is, e-mail that is not to be distributed outside of the appropriate domain. An e-mail can be designated as “company only” using any of a variety of mechanisms on an e-mail client user interface, including menu selection, icon selection, button selection, etc. Upon such designation, a company-only tag is embedded in the e-mail. It is desirable that the company-only tag be robust and tamper resistant. Methods of generating such a robust, tamper-resistant tag are known in the art.

In varying embodiments of the invention, mail client 104, mail server 102, firewall 105 and/or router 106 may contain a tag check module 108. Tag check module 108 operates to inspect e-mail data to determine if a company-only tag is present in the e-mail. If the company-only tag is present, the mail server, firewall, or router incorporating the tag check module 108 may use the methods described below to handle the e-mail so that it is not sent to recipients outside of the company. Some embodiments of the invention may require that all e-mails be submitted to the tag check module 108. Additionally, some embodiments of the invention have may require that all e-mails have tags associated with them-that is, either embedded within the e-mail or included in an designated database for reference purposes. The embodiments requiring that all e-mails have a tag include a type of tag which indicates that the e-mail may be sent outside the company, in addition to the aforementioned tags which prevent e-mail from being sent outside the company.

The following example will illustrate the operation of system 100. Assume that user A at client 104.1 decides to compose an e-mail that provides company confidential details regarding a new project at Bigco. Further assume that user A desires to send the e-mail to those within the company that have a need to know of the project. For purposes of this example, user B 104.2 and user D 112 have a legitimate need to know of the project. Now assume that user A designates users B and D as recipients of the e-mail, and inadvertently includes user C 122 as a recipient. Finally, assume that user A has designated the e-mail as “company only.”

In operation, system 100 can detect that the e-mail should not be sent to user C at one or more points within the system, depending on whether the particular component processing the e-mail has a tag check component 108. For example, tag check module 108.1 within user A's mail client may detect that user C is not within the bigco domain and refuse to transmit the e-mail to mail server 102. Additionally, tag check module 108.2 in mail server 102 may detect that user C is not within the bigco domain, and refuse to route the e-mail to through firewall 105 to router 106. Further, tag check module 108.3 in firewall 105 may detect the company-only tag and refuse to send the e-mail on to router 106. Finally, tag check module 108.4 in router 106 may examine data streams bound for network 130, and refuse to transmit e-mail data streams that are flagged as company-only that are sent to recipients that are not in an appropriate domain.

As those of skill in the art will appreciate, the tag generation module 107 and/or the tag check module 108 can be implemented separately or together as stand-alone modules, or in any one or more of mail server 102, mail client 104, firewall 105 and/or router 106. The invention is not limited to any particular combination of entities including the tag check module.

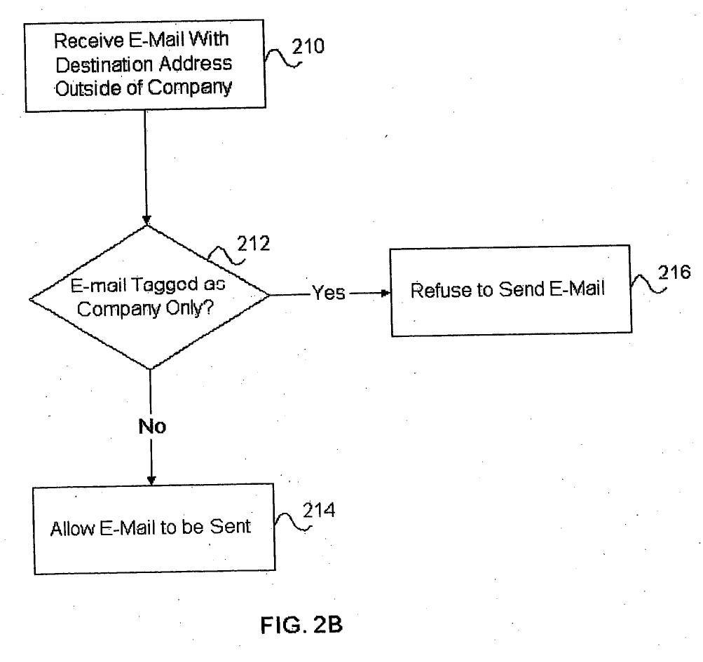

In the previous section, a system level overview of the operation of an exemplary embodiment of the invention was described. In this section, the particular methods of the invention performed by an operating environment executing an exemplary embodiment are described by reference to a series of flowcharts shown in FIGS. 2A-2B. The methods to be performed by the operating environment constitute computer programs made up of computer-executable instructions. Describing the methods by reference to a flowchart enables one skilled in the art to develop such programs including such instructions to carry out the methods on suitable computers (the processor of the computer executing the instructions from computer-readable media). The methods illustrated in FIGS. 2A-2B are inclusive of the acts performed by an operating environment executing an exemplary embodiment of the invention.

FIG. 2A is a flowchart illustrating a method for designating an e-mail as company-only. The method begins when a system executing the method, for example an e-mail client, receives an indication that the e-mail should be designated as company-only (block 202). The company-only designation may be made using an e-mail client user interface, which may include icon selection, menu selection, button selection, or command line entry.

Upon receiving such an indication, the system generates a company-only tag. In some embodiments, the tag is a predetermined value indicating that the e-mail is company-only (block 204). In alternative embodiments, the tag is specific to a particular company and is generated in a way such that the tag is tamper-resistant. Methods for generating a tamper-resistant value are known in the art.

Next, the tag is embedded in the e-mail (block 206). In some embodiments of the invention, the tag may be embedded in the header of the e-mail. In alternative embodiments, the tag is embedded in the body of the e-mail message. The tag may be introduced in the body by a keyword.

In some embodiments, once an e-mail is designated as company-only, the designation is prevented from being removed by e-mail processing software. This prevents a valid recipient within the company from removing the tag and then forwarding the e-mail to a non-company destination address.

FIG. 2B is a flowchart illustrating a method for processing company-only e-mail according to embodiments of the invention. The method begins when an e-mail processor, such as an e-mail client, e-mail server, firewall or router receives an e-mail object with a destination address outside of the company (block 210).

A check is made to determine if the e-mail contains a company-only tag (block 212). As noted above, the tag may be in the header or in the e-mail message body. If the e-mail is tagged as company-only, the e-mail processor prevents sending the e-mail (block 216). In some embodiments, this comprises not sending the e-mail to subsequent entities that might process the e-mail. For example, if the tag is detected within an e-mail client, the e-mail is not sent to an e-mail server for further processing. If the tag is detected within an e-mail server, the e-mail is not sent to a firewall or router for further processing. If the tag is detected by a firewall, the e-mail is not sent to a router for routing outside of the company. Finally, if the tag is detected by a router, the e-mail is not sent to any other router that is outside of the company. In some embodiments, the tag check module 108 (or the firewall or router) may strip the tag from the e-mail before sending it to its destination.

It should be noted that a firewall or router may be configured to know what routers are considered within a company and what routers are considered not within a company. This allows an e-mail to be sent to divisions or subsidiaries of a company even though the destination domain may be different from the sender's domain.

Otherwise, if the company-only tag is not present, the e-mail is allowed to be sent on (block 214).

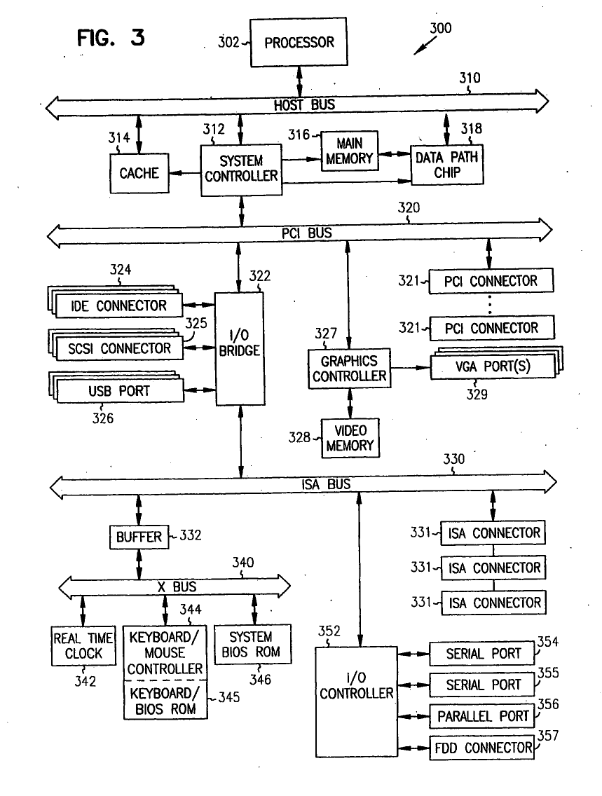

FIG. 3 is a block diagram of a computer system 300 that runs software programs that process company-only e-mail. For example computer system 300 can run mail server software, mail client software, firewall software or routing software.

Computer system 300 comprises a processor 302, a system controller 312, a cache 314, and a data-path chip 318, each coupled to a host bus 310. Processor 302 is a microprocessor such as a 486-type chip, a Pentium®, Pentium® II, Pentium® III, Pentium® 4, or other suitable microprocessor. Cache 314 provides high-speed local-memory data (in one embodiment, for example, 512 kB of data) for processor 302, and is controlled by system controller 312, which loads cache 314 with data that is expected to be used soon after the data is placed in cache 314 (i.e., in the near future). Main memory 316 is coupled between system controller 312 and data-path chip 318, and in one embodiment, provides random-access memory of between 16 MB and 256 MB or more of data. In one embodiment, main memory 316 is provided on SIMMs (Single In-line Memory Modules), while in another embodiment, main memory 316 is provided on DIMMs (Dual In-line Memory Modules), each of which plugs into suitable sockets provided on a motherboard holding many of the other components shown in FIG. 3. Main memory 316 includes standard DRAM (Dynamic Random-Access Memory), EDO (Extended Data Out) DRAM, SDRAM (Synchronous DRAM), or other suitable memory technology. System controller 312 controls PCI (Peripheral Component Interconnect) bus 320, a local bus for system 300 that provides a high-speed data path between processor 302 and various peripheral devices, such as graphics devices, storage drives, network cabling, etc. Data-path chip 318 is also controlled by system controller 312 to assist in routing data between main memory 316, host bus 310, and PCI bus 320.

In one embodiment, PCI bus 320 provides a 32-bit-wide data path that runs at 33 MHz. In another embodiment, PCI bus 320 provides a 64-bit-wide data path that runs at 33 MHz. In yet other embodiments, PCI bus 320 provides 32-bit-wide or 64-bit-wide data paths that run at higher speeds. In one embodiment, PCI bus 320 provides connectivity to I/O bridge 322, graphics controller 327, and one or more PCI connectors 321 (i.e., sockets into which a card edge may be inserted), each of which accepts a standard PCI card. In one embodiment, I/O bridge 322 and graphics controller 327 are each integrated on the motherboard along with system controller 312, in order to avoid a board-connector-board signal-crossing interface and thus provide better speed and reliability. In the embodiment shown, graphics controller 327 is coupled to a video memory 328 (that includes memory such as DRAM, EDO DRAM, SDRAM, or VRAM (Video Random-Access Memory)), and drives VGA (Video Graphics Adaptor) port 329. VGA port 329 can connect to industry-standard monitors such as VGA-type, SVGA (Super VGA)-type, XGA-type (eXtended Graphics Adaptor) or SXGA-type (Super XGA) display devices.

In one embodiment, graphics controller 327 provides for sampling video signals in order to provide digital values for pixels. In further embodiments, the video signal is provided via a VGA port 329 to an analog LCD display.

Other input/output (I/O) cards having a PCI interface can be plugged into PCI connectors 321. Network connections providing video input are also represented by PCI connectors 321, and include Ethernet devices and cable modems for coupling to a high speed Ethernet network or cable network which is further coupled to the Internet.

In one embodiment, I/O bridge 322 is a chip that provides connection and control to one or more independent IDE or SCSI connectors 324-325, to a USB (Universal Serial Bus) port 326, and to ISA (Industry Standard Architecture) bus 330. In this embodiment, IDE connector 324 provides connectivity for up to two standard IDE-type devices such as hard disk drives, CDROM (Compact Disk-Read-Only Memory) drives, DVD (Digital Video Disk) drives, videocassette recorders, or TBU (Tape-Backup Unit) devices. In one similar embodiment, two IDE connectors 324 are provided, and each provide the EIDE (Enhanced IDE) architecture. In the embodiment shown, SCSI (Small Computer System Interface) connector 325 provides connectivity for up to seven or fifteen SCSI-type devices (depending on the version of SCSI supported by the embodiment). In one embodiment, I/O bridge 322 provides ISA bus 330 having one or more ISA connectors 331 (in one embodiment, three connectors are provided). In one embodiment, ISA bus 330 is coupled to I/O controller 352, which in turn provides connections to two serial ports 354 and 355, parallel port 356, and FDD (Floppy-Disk Drive) connector 357. At least one serial port is coupled to a modem for connection to a telephone system providing Internet access through an Internet service provider. In one embodiment, ISA bus 330 is connected to buffer 332, which is connected to X bus 340, which provides connections to real-time clock 342, keyboard/mouse controller 344 and keyboard BIOS ROM (Basic Input/Output System Read-Only Memory) 345, and to system BIOS ROM 346.

The integrated system performs several functions identified in the block diagram and flowchart of FIGS. 1, 2A and 2B. Such functions are implemented in software in one embodiment, where the software comprises computer executable instructions stored on computer readable media such as disk drives coupled to connectors 324 or 325, and executed from main memory 316 and cache 314.

The invention can be embodied in a number of forms, for example, in the form of computer readable code, or other instructions, on a computer readable medium. Computer readable medium is any data storage device that can store code, instructions or other data that can be thereafter be read by a computer system or processor. Examples of the computer readable medium include read-only memory, random access memory, CD-ROMs, magnetic storage devices or tape, and optical data storage devices. The computer readable medium can configured within a computer system, communicatively coupled to a computer, or can be distributed over network-coupled computer systems so that the computer readable code is stored and executed in a distributed fashion.

### Conclusion

Systems and methods for processing company-only e-mail have been described. It should be noted that the terms “electronic mail” and “e-mail” have been used interchangeably herein, and are intended to have the same meaning. The systems and methods described provide advantages over previous systems. For example, an e-mail containing proprietary and/or confidential information, or an e-mail originating from a particular user or class of users, may be prevented from being sent to destination addresses outside of a company. The company-only aspect of the e-mail is enforced rather than being made advisory as in previous systems. Embodiments of the invention may be implemented by preventing certain individuals or categories of employees (e.g., clerks working with cost sensitive financial information) from sending e-mail outside the company. Embodiments of the invention may be implemented by preventing e-mail from being sent outside to particular designated individuals, e-mail addresses or companies (e.g., business competitors) rather than banning all outside e-mail. Another embodiment of the invention only allows e-mail to be sent outside the company to any of a list of predetermined authorized individuals, e-mail addresses or companies. In this embodiment a database of such authorized outside e-mail addresses is kept for each individual sending e-mail outside the company, or alternatively can be kept for various departments or for the whole company having this embodiment of the invention implemented.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

What is claimed is:

1. A system for sending and receiving electronic mail, the system comprising:
an electronic mail processor;
a tag generation module coupled to the electronic mail processor and operable to associate with an e-mail a tag relating to distribution of the e-mail; and
a tag check module coupled to the electronic mail processor and operable to detect the tag;
wherein the tag indicates to the electronic mail processor to refuse to send the e-mail to a destination address outside of a company.

2. The system of claim 1 wherein the electronic mail processor comprises an electronic mail client.

3. The system of claim 2, wherein the electronic mail client comprises a version of the Microsoft Outlook electronic mail client.

4. The system of claim 1, wherein the electronic mail processor comprises an electronic mail server.

5. The system of claim 4, wherein the electronic mail server comprises a version of the Microsoft Exchange electronic mail server.

6. The system of claim 1, wherein the electronic mail processor comprises a router.

7. The system of claim 1, wherein the electronic mail processor comprises a firewall.

8. A computerized method for processing electronic mail (e-mail), the method comprising:
receiving an e-mail object, the e-mail object having a source address within a company and a destination address outside of the company;
detecting whether the e-mail object has a tag indicating that the e-mail is a company-only e-mail; and
if the tag is detected then preventing the e-mail object from being sent to the destination address.

9. The computerized method of claim 8, wherein determining if the destination address is a company-only e-mail address comprises comparing a domain portion of the destination address with a domain portion of a source address.

10. The computerized method of claim 8, wherein determining if the destination address is a company-only e-mail address comprises determining if the e-mail object will be sent to a router capable of routing the e-mail object to the destination address.

11. The computerized method of claim 8, wherein preventing the e-mail object from being sent to the destination address comprises preventing the e-mail object from being sent to an e-mail server.

12. The computerized method of claim 8, wherein preventing the e-mail object from being sent to the destination address comprises preventing the e-mail object from being sent to a router within a company domain that routes to a second company outside of the company domain.

13. The computerized method of claim 8, wherein preventing the e-mail object from being sent to the destination address comprises preventing, by a router within the company domain, the e-mail object from being sent to a router outside of the company domain.

14. A computerized method for designating an e-mail as company-only, the method comprising:
receiving an indication that e-mail is company-only;
generating a company-only tag; and
embedding the company-only tag in the e-mail;

15. The method of claim 14, wherein the company-only tag is a tamper resistant tag.

16. The method of claim 14, wherein the company-only tag is embedded in the header of the e-mail.

17. The method of claim 14, wherein the company-only tag is embedded in the body of the e-mail.

18. A computer system comprising:
a processor;
a memory coupled to the processor;
an electronic mail processor executed by the processor in the memory; and
an tag check module coupled to the electronic mail processor and operable to detect a tag indicating to the electronic mail processor to refuse to send the e-mail to a destination address outside of a company.

19. The system of claim 18 wherein the electronic mail processor comprises an electronic mail client.

20. The system of claim 18, wherein the electronic mail processor comprises an electronic mail server.

21. The system of claim 18, wherein the electronic mail processor comprises a router.

22. The system of claim 18, wherein the electronic mail processor comprises a firewall.

23. A computer-readable medium having computer-executable instructions for processing electronic mail (e-mail), the method comprising:
receiving an e-mail object, the e-mail object having a source address within a company and a destination address outside of the company;
detecting whether the e-mail object has a tag indicating that the e-mail is a company-only e-mail; and
if the tag is detected then preventing the e-mail object from being sent to the destination address.

24. The computer-readable medium of claim 23, wherein determining if the destination address is a company-only e-mail address comprises comparing a domain portion of the destination address with a domain portion of a source address.

25. The computer-readable medium of claim 23, wherein determining if the destination address is a company-only e-mail address comprises determining if the e-mail object will be sent to a router capable of routing the e-mail object to the destination address.

26. The computer-readable medium of claim 23, wherein preventing the e-mail object from being sent to the destination address comprises preventing the e-mail object from being sent to an e-mail server.

27. The computer-readable medium of claim 23, wherein preventing the e-mail object from being sent to the destination address comprises preventing the e-mail object from being sent to a router within a company domain that routes to a second company outside of the company domain.

28. The computer-readable medium of claim 23, wherein preventing the e-mail object from being sent to the destination address comprises preventing, by a router within the company domain, the e-mail object from being sent to a router outside of the company domain.

29. A computer-readable medium having computer executable instructions for performing a method for designating an e-mail as company-only, the method comprising:
receiving an indication that e-mail is company-only;
generating a company-only tag; and
embedding the company-only tag in the e-mail;

30. The computer-readable medium of claim 29, wherein the company-only tag is a tamper resistant tag.

31. The computer-readable medium of claim 29, wherein the company-only tag is embedded in the header of the e-mail.

32. The computer-readable medium of claim 29, wherein the company-only tag is embedded in the body of the e-mail.
